(19) United States
(12) Patent Application Publication
(10) Pub. No.: US 2019/0043643 A1
(43) Pub. Date: Feb. 7, 2019

(54) ELECTRICAL LEAD

(71) Applicant: LEONI KABEL GMBH, NUERNBERG (DE)

(72) Inventors: ERWIN KOEPPENDOERFER, SCHWABACH (DE); MARKUS SCHILL, MUENCHEN (DE)

(21) Appl. No.: 16/052,868

(22) Filed: Aug. 2, 2018

(30) Foreign Application Priority Data
Aug. 2, 2017 (DE) 10 2017 213 441.0

(51) Int. Cl. H01B 7/288; H01B 7/00; H01B 3/44

(52) U.S. Cl. CPC H01B 7/288; H01B 3/441; H01B 3/446; H01B 7/0009

(57) ABSTRACT

An electrical lead has a lead core composed of a plurality of individual conduction elements and surrounded by a jacket of multiple plies that are formed by extrusion. An inner ply is formed of a swellable material. An outer ply surrounds the inner ply. Upon penetration of moisture, the swellable material of the inner ply swells up and fills out interstices between the conduction elements.

### CROSS-REFERENCE TO RELATED APPLICATION

This application claims the priority, under 35 U.S.C. § 119, of German application DE 10 2017 213 441.0, filed Aug. 2, 2017; the prior application is herewith incorporated by reference in its entirety.

### BACKGROUND OF THE INVENTION

### Field of the Invention

The invention relates to an electrical lead having a lead core composed of a plurality of individual conduction elements in strand form. The lead core is surrounded by a jacket.

A problem generally affecting electrical leads and cables is that because of leaks, such as in connection areas, at plugs, or else upon damage to the jacket, for example, moisture may penetrate into the interior of the lead or cable, from where it may propagate longitudinally along the individual conduction elements. A specific problem is that in some cases the moisture also penetrates narrow interstices and gusset areas between the individual conduction elements, and, because of the capillary effect, propagates even to locations far removed from the point of ingress.

This problem, referred to as longitudinal water imperviousness, is generally well known. There exist diverse approaches to making leads, cables or else entire cable sets impervious to longitudinal water penetration as far as possible.

All of the prior art measures, to some extent, involve increased cost and complexity and occasionally fail to result reliably in secure longitudinal sealing.

### SUMMARY OF THE INVENTION

It is accordingly an object of the invention to provide an electrical lead which overcomes the disadvantages of the heretofore-known devices and methods of this general type and to specify an electrical lead, with a lead core and a jacket surrounding it, with which the propagation of moisture within the lead is prevented as far as possible.

With the foregoing and other objects in view there is provided, in accordance with the invention, a electrical lead, comprising:

a lead core formed of a plurality of individual conduction elements;

a jacket formed of a plurality of plies surrounding said lead core, said plurality of plies of said jacket including an inner ply directly surrounding said lead core and an outer ply surrounding said inner ply, said inner and outer plies being extruded plies;

said inner ply being formed of a swellable material, which, upon moisture penetration, swells up and fills out interstices between said conduction elements.

In other words, the above objects are achieved, in accordance with the invention, by means of an electrical lead having a lead core composed of a plurality of individual conduction elements in strand form, the lead core being surrounded by a jacket which consists of a plurality of plies and comprises an inner ply and also an outer ply surrounding the inner ply. The two plies are configured as extruded plies, having thus been applied by an extrusion process. The inner ply here surrounds the lead core directly, in other words without the interposition of a further ply. The inner ply is formed, or consists, of a swellable material, and so on penetration of moisture, the swellable material of the inner ply swells up and fills out interstices between the conduction elements.

The two plies of the jacket here are produced, for example, by coextrusion. The overall effect of this is to create a lead which can be manufactured simply and cost-effectively using conventional production methods. At the same time, the lead has a longitudinally watertight design, by virtue of the special construction of the inner ply composed of a swellable material, insofar as in the event of penetration of moisture, the swellable material swells up and fills out the interstices which exist between the individual conduction elements in the original state. This, then, produces a seal, and the propagation of the penetrated moisture within the lead is reliably prevented. As a result of the extruded jacket ply configuration, the inner ply can be applied reliably and safely by conventional methods.

The conduction elements are particularly electrical conduction elements, being therefore configured for the transmission of electrical voltage/electric current. The elements in question may be conduction elements for data transmission and conduction elements for supply of power. Additionally, as well as the electrical conduction elements, there may also be further conduction elements integrated, examples being optical conduction elements such as optical waveguides.

The electrical lead may in particular be what is referred to as a jacketed lead, meaning that the jacket formed of the two plies forms an external jacket. An external jacket of this kind is typically characterized by being not surrounded by a further, concentrically disposed jacket ply. Such a jacket is frequently exposed directly to the ambient influences. Another possibility, furthermore, is that a plurality of such (jacketed) leads, optionally with further cable elements as well, form a cable system which customarily is further surrounded by a cable jacket.

In a useful development, the outer ply consists of a harder material than the inner ply. As a result of this measure, an outer rigid jacket ply is formed, so to speak, and ensures that in the event of the swelling of the inner jacket ply, the increase in volume resulting from the swelling is oriented at least primarily in the direction of the lead core. The outer ply therefore forms, so to speak, a rigid ring which undergoes very little or no radial expansion.

The construction of the lead, consisting of conduction elements and the interstices located between the conduction elements, and also of the inner ply and the outer ply, is usefully selected such that in the event of moisture penetration and of an assumed complete swelling of the swellable material, the change in volume of the inner ply is oriented to an extent of more than 50%, preferably more than 75%, radially inward in the direction of the lead core, and therefore does not result, or results only barely, in any radial expansion of the lead. Even in the case of a swollen inner ply, therefore, there is no alteration, or no substantial alteration, in an outer diameter of the lead, defined by the outer diameter of the outer ply. This outer diameter alters, for example, only by a maximum of 5% or a maximum of 2%. Preferably, however, the outer ply is selected such that there is no radial expansion of the outer ply. The result of this measure is to achieve high dimensional stability.

In accordance with an added feature of the invention, the outer ply is harder than the inner ply by a factor of at least 1.5, preferably by a factor of at least 2, or even by a factor of 3.

In accordance with an additional feature of the invention, the inner ply here has a Shore hardness in the range from 35 Shore A to 50 Shore D and more particularly in the range from 65 Shore A to 40 Shore D.

Usefully, moreover, the outer ply has a Shore hardness in a range from 92 Shore A to 85 Shore D and more particularly in a range from 95 Shore A to 65 Shore D.

In order to prevent the radial expansion, the inner ply and the outer ply preferably have different wall thicknesses, with the wall thickness of the outer ply being greater than that of the inner first ply. The thickness here is greater, for example, by a factor of at least 1.2 and preferably by a factor of at least 1.5 or else by a factor of at least 2 than the wall thickness of the inner ply. At maximum, the wall thickness of the outer ply is greater by a factor of preferably 3 or 4 than that of the inner ply.

In view of the desired simple fabrication by extrusion, the inner ply consists of a compounded formulation which comprises a superabsorbent and also a thermoplastic material. The thermoplastic material more particularly is a thermoplastic elastomer.

Superabsorbents (SAPs) are generally known and they readily available commercially. They are specialty polymers which are able to draw up, by suction, a multiple of their own weight or of their volume of polar fluids, such as water, for example. As it absorbs the fluid, a superabsorbent of this kind swells up and forms a hydrogel. Such superabsorbents are employed, for example, in the hygiene sector or else in building materials.

A superabsorbent based on a crosslinked sodium polyacrylate has proven particularly suitable.

Through the integration of such superabsorbents into a thermoplastic material, especially a thermoplastic elastomer, then, a readily processable, more particularly extrudable, swellable material is provided.

The fraction of the superabsorbent here is in particular in the range from 10 vol % to 80 vol % and more particularly in the range from 20 vol % to 60 vol %, and is for example 50 vol %, based on the total volume of the compounded formulation. This has the effect first of good processing properties, particularly extrudability, in conjunction with high swelling capacity on the part of the compounded formulation.

The compounded formulation preferably comprises an ethylene-vinyl acetate (EVA) as plastic elastomer. This thermoplastic elastomer has emerged in tests as being particularly suitable.

The superabsorbents are available commercially in the form of granules, for example. The same is true typically of thermoplastic materials which are suitable for extrusion. For compounding, the starting materials, particularly in granule form, are mixed with one another, and either a compounded granule formulation is produced, which is used for extrusion later on, or else the mixed granules are supplied directly to the extruder for the extrusion.

The inner ply in total is preferably formed by a homogeneous distribution of superabsorbent particles in a polymer matrix.

Overall, the compounded formulation is composed preferably of 15 vol % to 25 vol % of a superabsorbent, based in particular on the aforementioned crosslinked sodium polyacrylate; of 60 vol % to 95 vol % of the thermoplastic material, more particularly a thermoelastic elastomer, such as ethylene-vinyl acetate, for example; and of 0 to 25 vol % of additional substances. The latter are, for example, additives for setting other desired properties. Within these additional adjuvants, it is also possible to add in an elastomeric material, in order to establish a desired hardness on the part of the inner ply.

In a useful development, the outer jacket is formed of a thermoplastic material. A high-density polyethylene (HD-PE) is used especially for the outer jacket. High-density polyethylene refers to a polyethylene which has a density of typically 0.94 g/cm³ to 0.97 g/cm³. Such an HD-PE typically has a Shore D hardness in the range between 50 to 70. Contrasting with this, the Shore D hardness of EVA is typically only in the range between 17 and 45, and it is therefore much softer than HD-PE.

In principle, other conventional plastics with a correspondingly high hardness can also be employed for the outer ply. It is also possible, in principle, to replace EVA in the inner ply by other plastics.

According to a first variant, the lead core is a stranded conductor. The individual elements are therefore formed by individual strand wires. With this variant embodiment, then, in the event of penetration of moisture, the swellable material swells into individual interstices between the individual strand wires. Preference is given to using stranded conductors with a maximum of 3 or a maximum of 2 plies of strand wires, and therefore preferably to stranded conductors with a maximum 7 to 16 individual strand wires.

In the original state after production, and hence when no moisture has yet penetrated, the inner ply is in the form of an annular ply, in other words the form of a flexible tube. The material of the inner ply penetrates at most, in part, into outlying gusset regions of the lead core. In the interior of the lead core, however, there are free cavities. In the event of ingress of moisture, these cavities are only closed by the swelling material of the inner ply, preferably completely but at least to a large extent.

In an alternative variant, the lead core comprises a plurality of cores as conduction elements, and preferably consists exclusively of such cores. Each core here is formed by an electrical conductor and its immediately surrounding insulation, which is extruded on. The lead core in the case of a data lead, for example, is formed by a number of cores which for example are stranded with one another, being more particularly stranded in pairs with one another.

In a preferred embodiment, the outer jacket surrounds the inner jacket directly. That is, there are no other elements disposed between the outer jacket and the inner jacket. As a result of this, radial deformation of the inner ply on swelling, outwardly, is reliably prevented. Furthermore, the outer jacket in a preferred configuration, as already mentioned, is an exterior jacket of the electrical line assembly.

Other features which are considered as characteristic for the invention are set forth in the appended claims.

Although the invention is illustrated and described herein as embodied in an electrical lead, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows a cross section through a lead in the original state with an inner ply composed of a swellable material, and

FIG. 2 shows a cross section of the lead of FIG. 1 in the case where moisture has penetrated into the interior of the lead and the material of the inner ply is swollen.

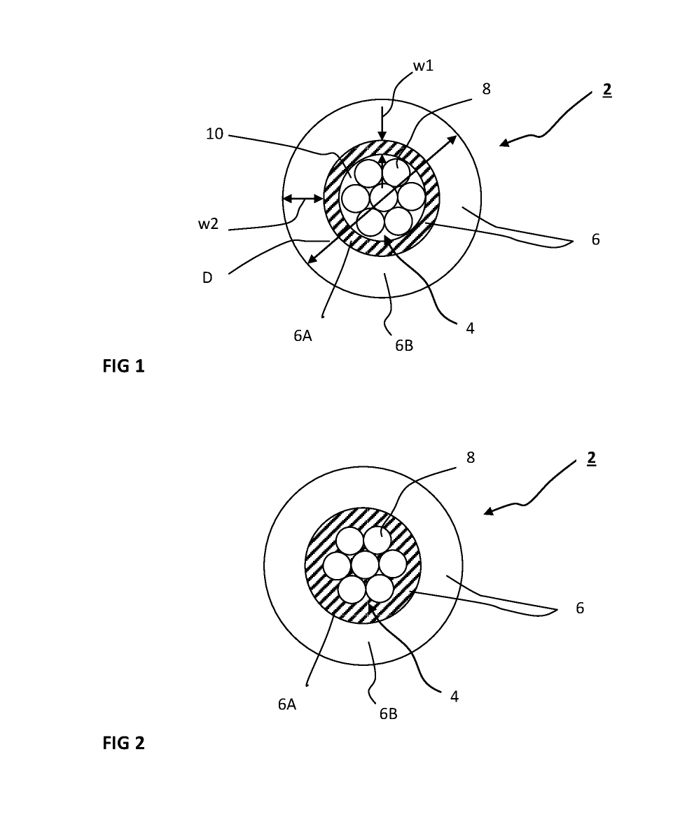

### DETAILED DESCRIPTION OF THE INVENTION

Referring now to the figures of the drawing in detail, there an exemplary embodiment of an electrical lead 2, which comprises a lead core 4 surrounded by a jacket 6. The jacket 6 is configured as a two-ply jacket, having an inner ply 6A and an outer ply 6B. The inner ply 6A surrounds the lead core 4 directly, and specifically in the manner of a flexible tube. The outer ply 6B surrounds the inner ply 6A, again directly. The lead 2 as a whole has an outer diameter D which is typically in the range from 0.5 to 5 mm, or else more.

The lead core 4 is formed by a plurality of conduction elements 8. In particular, the lead core 4 has at least two, preferably at least four, conduction elements 8. Usefully, a plurality of plies of conduction elements 8 are formed. In the exemplary embodiment depicted, a two-ply construction of the lead core 4 is shown, having a central conduction element 8, which, so to speak, forms the inner ply, and an outer ply consisting of six conduction elements 8. In the exemplary embodiment, the lead core 4 is formed specifically by a stranded conductor and the individual conduction elements 8 are configured as individual stranded wires, which preferably all in all form a stranded assembly. Alternatively, the conduction elements 8 used are cores.

The inner ply 6A has a first wall thickness w1 and the outer ply has a second wall thickness w2. The second, outer wall thickness w2 is preferably greater than the first, inner wall thickness w1.

The inner ply 6A consists of a swellable material which swells up on penetration of moisture. The hardness of this swellable material is preferably much lower than the hardness of the material of the outer ply 6B.

Specifically, for the inner ply, a compounded formulation is used that is composed of a superabsorbent with a thermoplastic elastomer. The volume fraction of the superabsorbent is usefully about 50 vol %, and the volume fraction of the thermoplastic elastomer, more particularly EVA (ethylene vinyl acetate), is 40 vol % to 50 vol %.

For the outer layer 6B, in turn, a comparatively hard material is used, as for example a polyamide (PA), a rigid PVC, a polyester elastomer, or an HDPE (high-density polyethylene).

As a result of this construction, and especially of the choice of the higher hardness for the outer ply 6B, specifically also in combination with the greater wall thickness, it is ensured in the event of moisture penetration that the material of the inner ply 6A undergoes inward expansion, at least primarily and preferably exclusively, and hence that interstices 10 between the individual conduction elements are reliably filled out with the material of the inner ply.

The latter condition is shown in FIG. 2. Here it is clearly apparent that all of the interstices 10 are filled out with the swellable material of the inner ply 6A. As a result, longitudinal water imperviousness (imperviosity) is ensured.

Studies have shown that with the construction described herein, it is possible to achieve the longitudinal water imperviosity of DIN EN 60794-1-22 (method F5B).

1. An electrical lead, comprising:
a lead core formed of a plurality of individual conduction elements;
a jacket formed of a plurality of plies surrounding said lead core, said plurality of plies of said jacket including an inner ply directly surrounding said lead core and an outer ply surrounding said inner ply, said inner and outer plies being extruded plies;
said inner ply being formed of a swellable material, which, upon moisture penetration, swells up and fills out interstices between said conduction elements.

2. The electrical lead according to claim 1, wherein said outer ply consists of a material that is harder than the material of said inner ply.

3. The electrical lead according to claim 2, wherein said outer ply is harder by a factor of at least 2 than said inner ply.

4. The electrical lead according to claim 1, wherein said inner ply has a Shore hardness in a range from 35 Shore A to 50 Shore D.

5. The electrical lead according to claim 1, wherein said outer ply has a Shore hardness in a range from 92 Shore A to 85 Shore D.

6. The electrical lead according to claim 1, wherein said inner ply has a first wall thickness and said outer ply has a second wall thickness, said second wall thickness being greater than said first wall thickness.

7. The electrical lead according to claim 1, wherein said inner ply consists of a compounded formulation comprising a superabsorbent and a thermoplastic material.

8. The electrical lead according to claim 7, wherein a fraction of said superabsorbent within said compounded formulation is in a range from 10 vol % to 80 vol %.

9. The electrical lead according to claim 7, wherein said thermoplastic material of said compounded formulation comprises an ethylene-vinyl acetate.

10. The electrical lead according to claim 7, wherein said compounded formulation is composed of:
35 vol % to 55 vol % of said superabsorbent;
40 vol % to 65 vol % of said thermoplastic material; and
0 to 25 vol % of additional substances.

11. The electrical lead according to claim 1, wherein said outer jacket consists of a thermoplastic material.

12. The electrical lead according to claim 11, wherein said thermoplastic material is high-density polyethylene.

13. The electrical lead according to claim 1, wherein said lead core is a stranded conductor and said individual conduction elements are individual strand wires.

14. The electrical lead according to claim 1, wherein said lead core consists of a plurality of cores forming said conduction elements, each said core being formed by a conductor and a surrounding insulation.

15. The electrical lead according to claim 1, wherein said outer jacket directly surrounds said inner jacket and is in contact therewith.

16. The electrical lead according to claim 1, wherein said outer jacket is an exterior jacket.
